(19) United States
(12) Patent Application Publication
(10) Pub. No.: US 2017/0046199 A1
(43) Pub. Date: Feb. 16, 2017

(54) MIGRATING OBJECTS FROM A SOURCE SERVICE TO A TARGET SERVICE

(71) Applicant: HEWLETT PACKARD ENTERPRISE DEVELOPMENT LP, Houston, TX (US)

(72) Inventors: Jeffrey William Kramer, Austin, TX (US); William Christopher Johnson, Greenville, SC (US); Michael Walter Hagedorn, Alcoa, TN (US)

(73) Assignee: Hewlett-Packard Development Company, L.P., Houston, TX (US)

(21) Appl. No.: 15/304,226

(22) PCT Filed: Apr. 30, 2014
(86) PCT No.: PCT/US2014/036193

§ 371 Date: Oct. 14, 2016

(51) Int. Cl. G06F 9/48; G06F 9/50

(52) U.S. Cl. CPC G06F 9/4856; G06F 9/5083

(57) ABSTRACT

Migrating objects from a source service to a target service includes with a migrating system, generating a migration list, the migration list includes a number of objects to migrate from a source service to a target service, loading a number of object migration jobs into a network-accessible work queue, the object migration jobs representing tasks that define how the objects are to migrate, retrieving, from the network-accessible work queue, the object migration jobs via a number of workers, loading the objects from the source service into the target service via the number of workers, and validating file checksums of the objects to ensure data integrity of the objects.

### BACKGROUND

Storage providers store large amounts of data for customers who may be operating services that generate a lot of data. A large collection of data may be referred to as objects. The data for each customer may be stored in a datacenter, a server, other locations, or combinations thereof. Further, the storage providers ensure that each of the customers may have access to their data when desired.

### BRIEF DESCRIPTION OF THE DRAWINGS

The accompanying drawings illustrate various examples of the principles described herein and are a part of the specification. The examples do not limit the scope of the claims.

FIG. 1 is a diagram of an example of a system for migrating objects from a source service to a target service, according to one example of principles described herein.

FIG. 2 is a diagram of an example of migrating objects from a source service to a target service, according to one example of principles described herein.

FIG. 3 is a flowchart of an example of a method for migrating objects from a source service to a target service, according to one example of principles described herein.

FIG. 4 is a flowchart of an example of a method for migrating objects from a source service to a target service, according to one example of principles described herein.

FIG. 5 is a diagram of an example of a migrating system, according to one example of principles described herein.

FIG. 6 is a diagram of an example of a migrating system, according to one example of principles described herein

Throughout the drawings, identical reference numbers designate similar, but not necessarily identical, elements.

### DETAILED DESCRIPTION

As mentioned above, storage providers store large amounts of data, such as objects, for customers that operate services generating a lot of data. The data for each customer may be stored in a datacenter, a server, other locations, or combinations thereof. Further, the storage providers ensure that each of the customers may have access to their data when desired.

However, a storage provider may cease operation with little warning. As a result, the customer's data needs to be transferred to another storage provider or the customer risks losing all of their data. This can result in a difficult issue for the customer.

Significant technical challenges can arise when transferring the customers data to another storage provider. For example, a storage provider may limit the customer's bandwidth making it difficult to quickly transfer the entire volume of data. For example, a bandwidth limit may result in throttling simultaneous connections by the customer as well as produce high error rates for the customer's data. As indicated, these may be significant technical challenges to address a short pre-shutdown window given by the storage provider.

The principles described herein include a method for migrating objects from a source service to a target service. Such a method includes, with a migrating system, generating a migration list, the migration list includes a number of objects to migrate from a source service to a target service, loading a number of object migration jobs into a network-accessible work queue, the object migration jobs representing tasks that define how the objects are to migrate, retrieving, from the network-accessible work queue, the object migration jobs via a number of workers, loading the objects from the source service into the target service via the number of workers, and validating file checksums of the objects to ensure data integrity of the objects. Such a method allows large amounts of data to migrate from a source service to a target service. As a result, a large amount of data, for a customer, migrates from one storage provider to another storage provider without losing data.

In the present specification and in the appended claims, the term “objects” is meant to be understood broadly as a customer's data that is to migrate from a source service to a target service. In one example, the objects may include images, text, audio, videos, other objects, or combinations thereof.

In the present specification and in the appended claims, the term “source service” is meant to be understood broadly as a storage provider that is currently storing a customer's objects. In one example, the source service may store the customer's objects on a server, a datacenter, other storage locations, or combinations thereof.

In the present specification and in the appended claims, the term “target service” is meant to be understood broadly as a storage provider that the customer's objects need to migrate to. In one example, the target service may store the customer's objects on a server, a datacenter, other storage locations, or combinations thereof.

In the present specification and in the appended claims, the term “worker” is meant to be understood broadly as an executable computer program such as a script. In one example, the worker is responsible for query a network-accessible work queue for available object migration jobs. Further, the worker may execute across multiple processes, servers, services, databases, or combinations thereof.

In the present specification and in the appended claims, the term “object migration jobs” is meant to be understood broadly as tasks that define how objects migrate from a source service to a target service. In one example, the object migration jobs may specify that a worker is to pull objects from a source service and push the objects into a target service. In another example, the object migration jobs may specify that a worker is to pull objects from a source service and push the objects into a third service. Further, the object migration jobs may specify that a worker is to pull the objects from the third service and push the objects into a target service

Further, as used in the present specification and in the appended claims, the term “a number of” or similar language is meant to be understood broadly as any positive number comprising 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

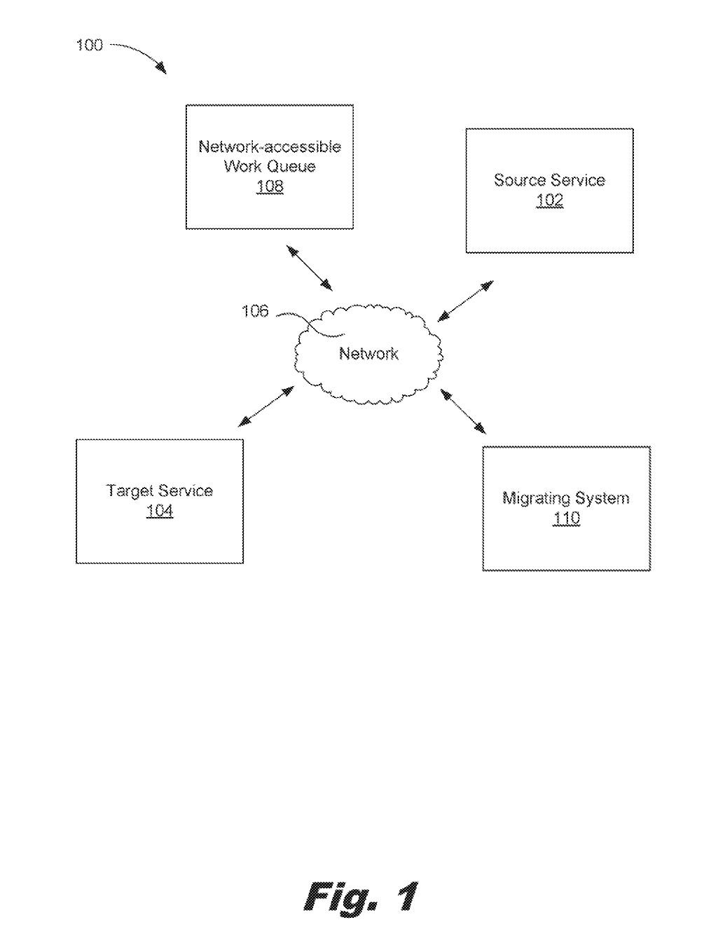

Referring now to the figures. FIG. 1 is a diagram of an example of a system for migrating objects from a source service to a target service, according to one example of principles described herein. As will be described below, a migrating system is in communication with a network to generate a migration list. The migration list may include a number of objects to migrate from a source service to a target service. Further, the migrating system loads a number of object migration jobs into a network-accessible work queue, the object migration jobs representing tasks that define how the objects are to migrate. Further, the migrating system retrieves, from the network-accessible work queue, the object migration jobs via a number of workers. Still Further, the migrating system loads the objects from the source service into the target service. Finally, the migrating system validates file checksums of the objects to ensure data integrity of the objects.

As illustrated in FIG. 1, the system (100) includes a source service (102). As mentioned above, the source service (102) may be a storage provider that is currently storing a customer's objects. In one example, the source service (102) stores the customer's objects on a server, a datacenter, other storage locations, or combinations thereof.

Further, as illustrated in FIG. 1, the system (100) includes a target service (104). The target service (104) may be a storage provider that the customer's objects need to migrate to. In one example, the target service (104) will store the customer's objects a server, a datacenter, other storage locations, or combinations thereof.

The system (100) further includes a migrating system (110). In keeping with the given example, the migrating system (110) generates a migration list. The migration list may include a number of objects to migrate from the source service (102) to the target service (104).

The migrating system (110) loads a number of object migration jobs into a network-accessible work queue (108). As will be described below, the object migration jobs may be represented as tasks that define how the objects are to migrate. In one example, the network-accessible work queue (108) may be a structured query language (SQL) queue, an optimized queue, or a queue service. Further, the network-accessible work queue (108) may be accessed by any device connected to the network (106).

The migrating system (110) retrieves, from the network-accessible work queue (108), the object migration jobs via a number of workers. In one example, the number of workers may execute across multiple processes, servers, services, databases, or combinations thereof. In this example, the number of workers may execute across the network (106), the source service (102), or the target service (104).

Further, the migrating system (110) loads the objects from the source service (102) into the target service (104) via the number of workers. In one example, the migrating system (110) loads the objects into the target service (104) one object at a time.

The migrating system (110) validates file checksums of the objects to ensure data integrity of the objects. In one example, validating the file checksums of the objects to ensure the data integrity of the objects includes exporting total object counts, names of the objects, metrics, or combinations thereof. As a result, a customer's objects migrate from one storage provider to another storage provider without losing data. More information about the migrating system (110) will be described later on in this specification.

While this example has been described with reference to the migrating system being located over the network, the migrating system may be located in any appropriate location according to the principles described herein. For example, the migrating system may be located in a user device, a server, a datacenter, a target service, a source service, other locations, or combinations thereof.

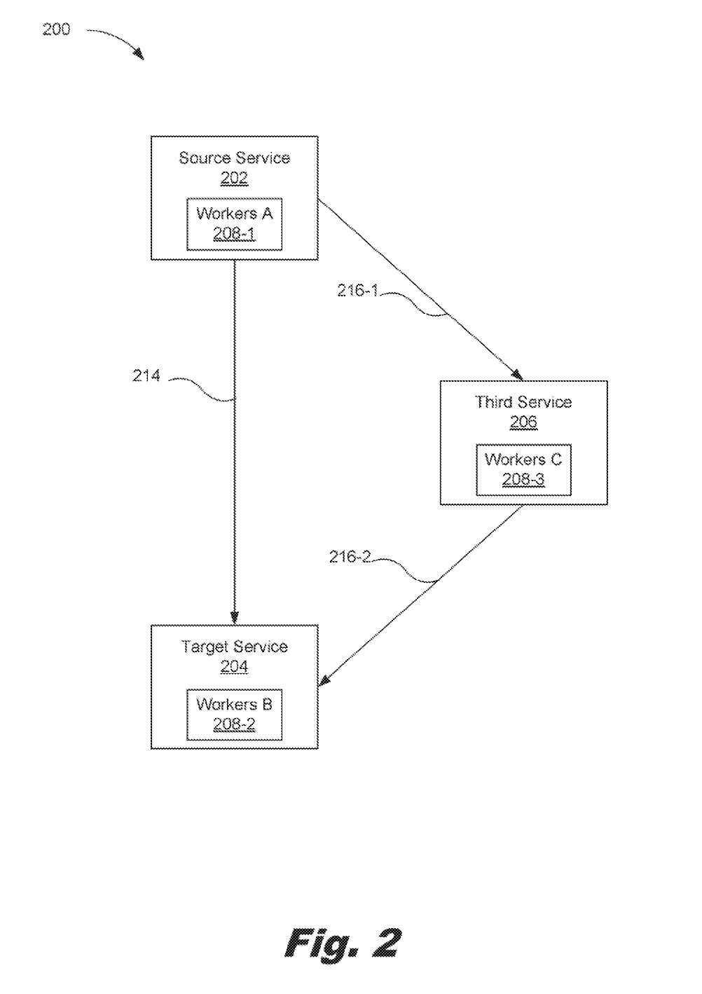

FIG. 2 is a diagram of an example of migrating objects from a source service to a target service, according to one example of principles described herein. As mentioned above, a migrating system is in communication with a network to generate a migration list, the migration list may include a number of objects to migrate from a source service to a target service. Further, the migrating system loads a number of object migration jobs into a network-accessible work queue, the object migration jobs representing tasks that define how the objects are to migrate. Further, the migrating system retrieves, from the network-accessible work queue, the object migration jobs via a number of workers. Still Further, the migrating system loads the objects from the source service into the target service. Finally, the migrating system validates file checksums of the objects to ensure data integrity of the objects.

As illustrated in FIG. 2, the system (200) includes a source service (202), a target service (204), and a third service (206). As illustrated, workers (208) may execute on one of the services (202, 204, 206). For example, workers A (208-1) that may execute on the source service (202). Workers B (208-2) that may execute on the target service (204). Workers C (208-3) that may execute on the third service (206).

In one example, performance demands make executing workers at the source service (202) advantageous. As a result, only workers A (208-1) execute in the system (200). In this example, workers A (208-1) execute at the source service (202). However, this can be risky if the source service (202) is antagonistic. In this example, the objects migrate, via the migrating system of FIG. 1, from the source service (202) to the target service (204) as indicated by arrow 214.

In another example, executing workers inside of the target service (204) is the most desirable This may be desirable since users may be able to migrate with excess virtual machine (VM) capacity and bundle the bandwidth and compute cost into a contract. As a result, only workers B (208-1) execute in the system (200). In this example, workers B (208-2) execute at the target service (204). The objects migrate, via the migrating system of FIG. 1, from the source service (202) to the target service (204) as indicated by arrow 214.

In another example, workers may reside in the third service (206). In one example, the third service (206) may be the public head-end of a secure private datacenter where the target service (204) is not directly accessible from the source service (202). As a result only workers C (208-3) execute in the system (200). In this example, workers C (208-3) execute at the third service (206). The objects migrate from the source service (202) to the third service (206) as indicated by arrow 216-1 via the migrating system of FIG. 1. Then, the objects migrate from the third service (206) to the target service (204) as indicated by arrow 216-2 via the migrating system of FIG. 1.

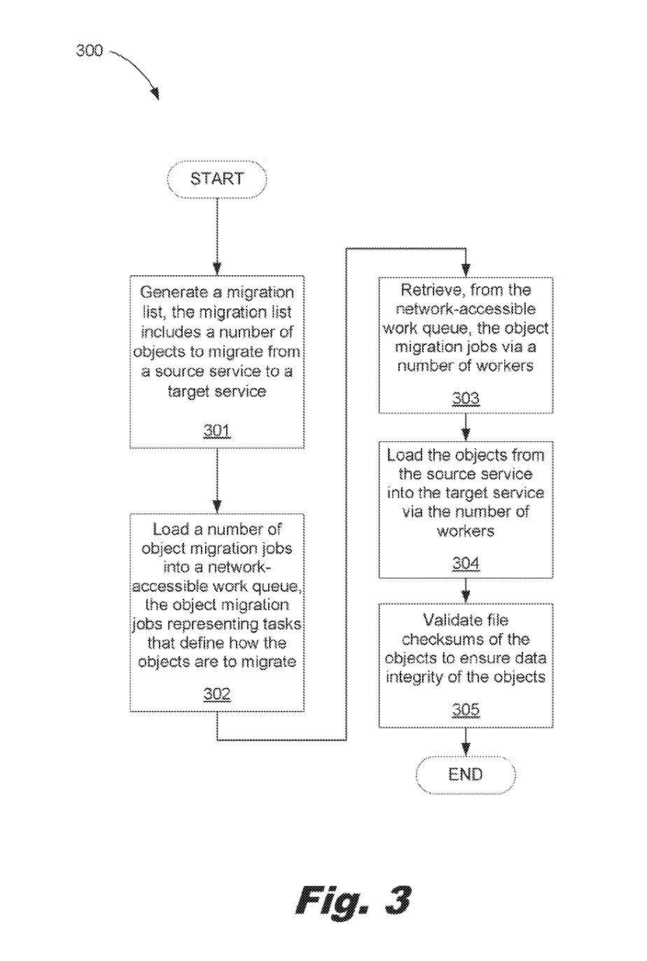

FIG. 3 is a flowchart of an example of a method for migrating objects from a source service to a target service, according to one example of principles described herein. In one example, the method (300) may be executed by the system (100) of FIG. 1. In other examples, the method (300) may be executed by other systems such as system 500 or system 600. In this example, the method (300) includes, with a migrating system, generating (301) a migration list, the migration list includes a number of objects to migrate from a source service to a target service, loading (302) a number of object migration jobs into a network-accessible work queue, the object migration jobs representing tasks that define how the objects are to migrate, retrieving (303), from the network-accessible work queue, the object migration jobs via a number of workers, loading (304) the objects from the source service into the target service via the number of workers, and validating (305) file checksums of the objects to ensure data integrity of the objects.

As mentioned above, the method (300) uses a migrating system. By imbuing the migrating system with adaptive intelligence and preset parameters for common scenarios informed by real workloads, the migrating system is simple enough for sales teams to use without engineer support However, the migrating system is still adaptable for custom, time-sensitive migrations. In addition, by designing the migrating system to be modular, components of the migrating system can be deployed in appropriate network locations. Further, the migrating system can be rapidly upgraded for specific storage provider and partner demands. Because all the pieces of the migrating system are part of one whole, the migrating system leverages performance optimizations and lessons from past migrations. This improves the time-to-first-copy, decreases the error and retry rate for objects, and decreases time-to-completion.

As mentioned above, the method (300) includes generating (301) a migration list, the migration list includes a number of objects to migrate from a source service to a target service. In one example, the migrating system supports CSV object lists and APIs for a number of customers. The CSV object lists and the APIs define how the objects in the migration list are delivered to the workers.

In one example, for time-sensitive migrations, a storage provider, such as a source service or a target service, may make custom modifications to the listing process. In one example, a directory structure for a customer's API may be deep. In this example, the directory structure includes single objects in leaf nodes of a tree. Further, the customer's API may not allow a recursive listing of directories. As a result, the migrating system requests millions of API to list all of the objects.

In another example, in order to avoid worker starvation, the workers must process the directory as fast as possible. As a result, the migrating system supports lightweight greenlet coroutines to list dozens or hundreds of different top-level directories at once for a migration list. However, for optimal efficiency the migrating system processes sequentially to conserve random access memory (RAM) past a set directory depth.

In still another example, for services which support time-expiring uniform resource locators (URL) for object retrieval, the migrating system generates URL signatures when generating a migration list. For storage providers that don't support cryptographic signing by the client, multiple URLs are requested in batches for optimal performance. As a result, the workers are free to focus on maximum copy speed.

As mentioned above, the method (300) includes loading (302) a number of object migration jobs into a network-accessible work queue, the object migration jobs representing tasks that define how the objects migrate. As mentioned above, the network-accessible work queue may be a SQL queue, an optimized queue, or a queue service. With millions of objects and dozens of workers, the network-accessible work queue performance may become a potential bottleneck. SQL based queues are easy to deploy and can scale to multi-million object migration workloads, but table read lock tuning is an issue. Further, object migration jobs may be dequeued in large batches to reduce congestion in the network-accessible work queue.

As the objects are listed in the migration list, object migration jobs are loaded into the network-accessible work queue. The object migration jobs processing may use one or more workers, executing in one of three locations as described in FIG. 2. As indicated, performance demands make executing the workers at the source service advantageous. However, this can be risky, especially if the source service is antagonistic. Executing the workers inside of the target service is the most desirable, since users may be able to migrate with excess VM capacity and bundle the bandwidth and compute cost into a customer's contract. Further, the migration workers can reside in a different service. For example, a public head-end of a secure private service where the target service is not directly accessible from the source service.

As mentioned above, the method (300) includes retrieving (303), from the network-accessible work queue, the object migration jobs via a number of workers. Once the network-accessible work queue begins to fill, a set of workers are started. The workers query for available object migration jobs on startup, allowing pre-loaded worker VM images to be staged in a compute service and deployed in minutes. In one example, the workers execute across multiple processes, servers, services, databases, or combinations thereof. Further, the workers may be optimized to meet the demands of a specific migration.

In one example, the workers may be computer program executable scripts. The workers may be written in any computer program language. Further, the workers may use a gevent greenlet-based library for event-driven network communication. This allows the workers to use common provider supplied API libraries to drastically reduce development time, while still enjoying high single-process performance. This can result in throughput rates of over one-hundred megabits per second (Mbps) on a single VM even with files under one megabyte. In this case, multiple worker processes are executed to saturate available resources such as processing cores.

With small file migrations, greenlet switching and hypertext transfer protocol secure (HTTPS) connection oversee the starting and stopping of tens of thousands of requests per minute. As a result, migrations of primarily larger objects will likely be limited by VM network bandwidth. Further, scaling a migration's throughput is a matter of starting more workers on the VMs until the network's bandwidth is saturated.

As mentioned above, the method (300) includes loading (304) the objects from the source service into the target service In one example, the object migration jobs may specify that a worker is to pull objects from a source service and push the objects into a target service. In another example, the object migration jobs may specify that a worker is to pull objects from a source service and push the objects into a third service. Further, the object migration jobs may specify that a worker is to pull objects from the third service and push the objects into a target service. As a result, the method (300) loads the objects from the source service into the target service in a single process.

As mentioned above, the method (300) includes validating (305) file checksums of the objects to ensure data integrity of the objects. In one example, validating the file checksums of the objects to ensure the data integrity of the objects includes exporting total object counts, names of the objects, metrics, or combinations thereof. In this example, the total object counts, the names of the objects, and the metrics may be display to a user, via a user interface (UI), to show completion.

For example, the UI may indicate that one-hundred out of one-hundred objects migrated from the source service to the target service. The UI may further display the name of each of the one-hundred objects. Further, the UI may display metrics such as a completion time, error rate, other metrics or combinations thereof to the user.

In one example, maintaining data consistency is the highest priority for the migration system. If a message digest function for checksums of objects is available, the migration system pulls them from the source service, stores them in the network-accessible work queue, and pushes them for validation to the target service when an object is stored.

In one example, checksum match failures are retried up to a predetermined limit and then flagged for manual cleanup. In this example, workers flag broken connection or other copy errors in the network-accessible work queue as they execute. This allows for re-queuing and recovery from service outages and temporary blacklisting.

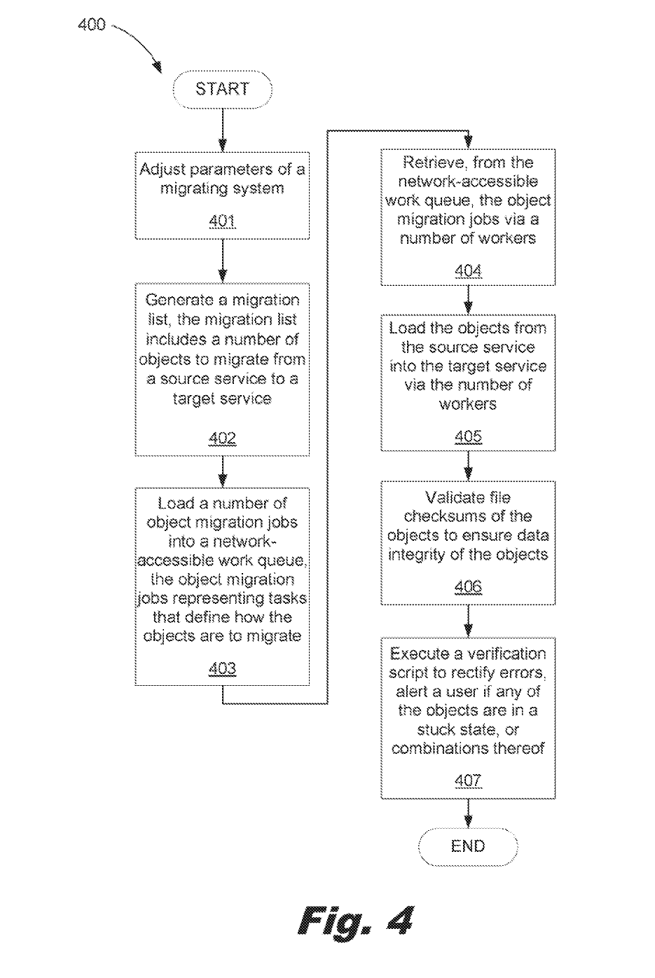

FIG. 4 is a flowchart of an example of a method for migrating objects from a source service to a target service, according to one example of principles described herein. In one example, the method (400) may be executed by the system (100) of FIG. 1. In other examples, the method (400) may be executed by other systems such as system 500 or system 600. In this example, the method (400) includes with a migrating system, adjusting (401) parameters of the migrating system, generating (402) a migration list, the migration list includes a number of objects to migrate from a source service to a target service, loading (403) a number of object migration jobs into a network-accessible work queue, the object migration jobs representing tasks that define how the objects are to migrate, retrieving (404), from the network-accessible work queue, the object migration jobs via a number of workers, loading (405) the objects from the source service into the target service via the number of workers, validating (406) file checksums of the objects to ensure data integrity of the objects, and executing (407) a verification script to rectify error, alert a user if any of the objects are in a stuck state, or combinations thereof.

As mentioned above, the method (400) includes adjusting (401) parameters of the migrating system. In one example, the migrating system includes tunable parameters for each phase in the migration process. This has proven significant, especially when storage providers cease operation with little warning, such that deadlines for migrating a customer's objects cannot be extended. In one example, the migrating system's parameters are focused on nondestructive shutdowns and restarts, retry timing, simultaneous connections, and buffer sizes. The migrating system may include defaults for the parameters. However, the parameters may be adjusted via a UI.

As mentioned above, nondestructive shutdowns and restarts may be adjusted for the migrating system. In one example, for time-sensitive migrations, the migrating system's parameters are adjusted such that a source service, a target service, or other services do not restart or shutdown. As a result, the migrating system migrates a customer's objects from the source service to the target service faster.

As mentioned above, retry timing may be adjusted for the migrating system. In one example, the retry timing may be adjusted to retry the migration process of an object based on factors such as an event, a time, other factors, or combinations thereof.

In one example, simultaneous connections may be adjusted for the migrating system. For example, the migrating system may allow three simultaneous connections at once. In another example, the migrating system may allow ten simultaneous connections at once.

As mentioned above, buffer size may be adjusted for the migrating system. In one example, the buffer size may be adjusted to accommodate large or small migrations. For example, a larger buffer size may be used to accommodate large migrations.

As a result, the parameters of the migrating system are adjusted to optimize non-destructive shutdowns and restarts, retry timing, simultaneous connections, buffer size, or combinations thereof. Further, the migrating system may include an adaptive error correction in the workers to back off in case of high error rates or blacklisting allows the workers to be executed by non-specialized staff, with as little as a single page of instructions.

As mentioned above, the method (400) includes executing (407) a verification script to rectify error, alert a user if any of the objects are in a stuck state, or combinations thereof. In one example, once the entire network-accessible work queue is processed, a verification script is executed to rectify errors and alert staff to any objects which may be in a stuck state. In one example, the stuck state may include the source service indicating that an object needs to migrate to the target service. However, the migrating system could not retrieve the object form the source service.

In one example, an error may be in an authorization process. In this case, the validation script retries each object, which includes an error in the authorization process, in the network-accessible work queue from the beginning of the method (400). In real world migrations this has resulted in a very high success rate, even with storage providers which are suffering from significant service degradation

FIG. 5 is a diagram of an example of a migrating system, according to one example of principles described herein. The migrating system (500) includes a generating engine (502), an object migration job loading engine (504), a retrieving engine (506), an object loading engine (508), and a validating engine (510). In this example, the migrating system (500) also includes an adjusting engine (512), and an executing engine (514). The engines (502, 504, 506, 508, 510, 512, 514) refer to a combination of hardware and program instructions to perform a designated function. Each of the engines (502, 504, 506, 508, 510, 512, 514) may include a processor and memory. The program instructions are stored in the memory and cause the processor to execute the designated function of the engine.

The generating engine (502) generates a migration list, the migration list includes a number of objects to migrate from a source service to a target service. In one example, the generating engine (502) generates one migration list In another example, the generating engine (502) generates several migration lists.

The object migration job loading engine (504) loads a number of object migration jobs into a network-accessible work queue, the object migration jobs representing tasks that define how the objects are to migrate. In one example, the network-accessible work queue may be a SQL queue, an optimized queue, or a queue service.

The retrieving engine (506) retrieves, from the network-accessible work queue, the object migration jobs via a number of workers. In one example, the number of workers execute across multiple processes, servers, services, databases, or combinations thereof.

The object loading engine (508) loads the objects from the source service into the target service via the number of workers. In one example, the object loading engine (508) loads one object at a time into the target service. In another example, the object loading engine (508) loads all the objects into the target service at the same time.

The validating engine (510) validates file checksums of the objects to ensure data integrity of the objects. In one example, the validating engine (510) validates the file checksums of the objects to ensure the data integrity of the objects by exporting total object counts, names of the objects, metrics, or combinations thereof.

The adjusting engine (512) adjusts parameters of the migrating system. In one example, the adjusting engine (512) adjusts parameters to optimize non-destructive shutdowns and restarts, retry timing, simultaneous connections, buffer size, or combinations thereof.

The executing engine (514) executes a verification script to rectify error, alert a user if any of the objects are in a stuck state, or combinations thereof. In one example, the executing engine (514) executes one verification script. In another example, the executing engine (514) executes several verification scripts.

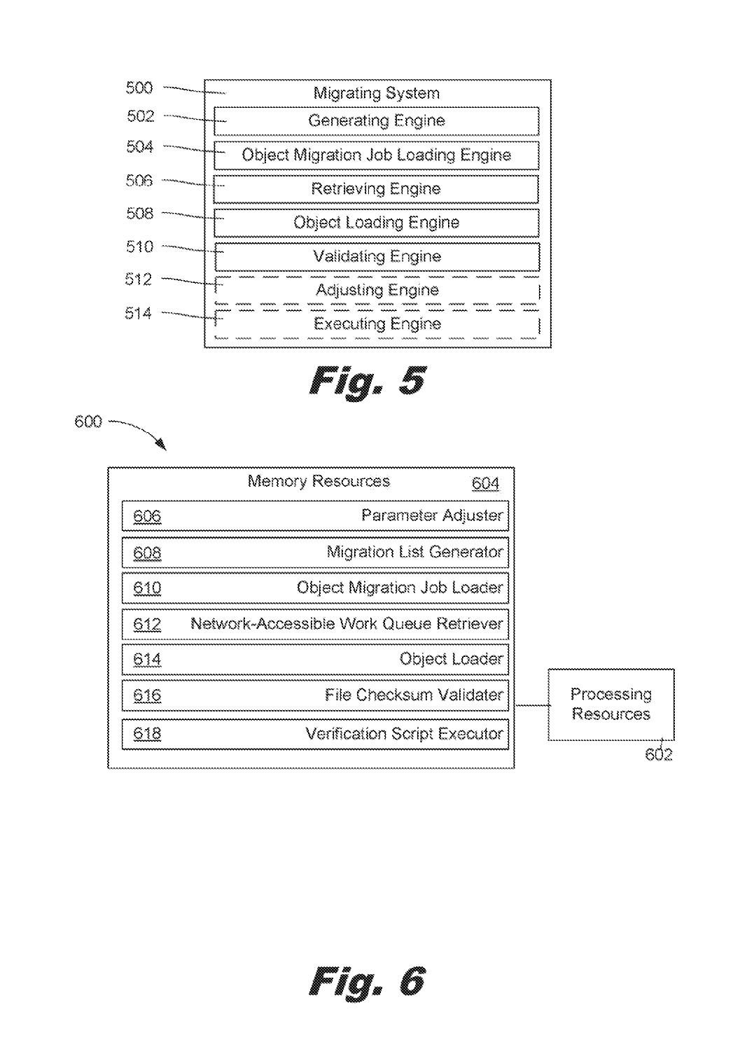

FIG. 6 is a diagram of an example of a migrating system, according to one example of principles described herein In this example, migrating system (600) includes processing resources (602) that are in communication with memory resources (604). Processing resources (602) include at least one processor and other resources used to process programmed instructions. The memory resources (604) represent generally any memory capable or storing data such as programmed instructions or data structures used by the migrating system (600). The programmed instructions shown stored in the memory resources (604) include a parameter adjuster (606), a migration list generator (608), an object migration job loader (610), a network-accessible work queue retriever (612), an object loader (614), a file checksum validator (616), and a verification script executor (618).

The memory resources (604) include a computer readable storage medium that contains computer readable program code to cause tasks to be executed by the processing resources (602). The computer readable storage medium may be tangible and/or physical storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, or types of memory, or combinations thereof.

The parameter adjuster (606) represents programmed instructions that, when executed, cause the processing resources (602) to adjust parameters of the migrating system (600). The migration list generator (608) represents programmed instructions that, when executed, cause the processing resources (602) to generate a migration list, the migration list includes a number of objects to migrate from a source service to a target service.

The object migration jobs loader (610) represents programmed instructions that, when executed, cause the processing resources (602) to load a number of object migration jobs into a network-accessible work queue, the object migration jobs representing tasks that define how the objects are to migrate. The network-accessible work queue retriever (612) represents programmed instructions that, when executed, cause the processing resources (602) to retrieve, from the network-accessible work queue, the object migration jobs via a number of workers.

The object loader (614) represents programmed instructions that, when executed, cause the processing resources (602) to load the objects from the source service into the target service. The file checksum validator (616) represents programmed instructions that, when executed, cause the processing resources (602) to validate file checksums of the objects to ensure data integrity of the objects. The verification script executor (618) represents programmed instructions that, when executed, cause the processing resources (602) to execute a verification script to rectify error, alert a user if any of the objects are in a stuck state, or combinations thereof.

Further, the memory resources (604) may be part of an installation package. In response to installing the installation package, the programmed instructions of the memory resources (604) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (602) and the memory resources (602) are located within the same physical component, such as a server, or a network component. The memory resources (604) may be part of the physical component's main memory, caches, registers, non-volatile memory, or elsewhere in the physical component's memory hierarchy. Alternatively, the memory resources (604) may be in communication with the processing resources (602) over a network. Further, the data structures, such as the libraries, may be accessed from a remote location over a network connection while the programmed instructions are located locally. Thus, the migrating system (600) may be implemented on a user device, on a server, on a collection of servers, or combinations thereof.

The migrating system (600) of FIG. 6 may be part of a general purpose computer. However, in alternative examples, the migrating system (600) is part of an application specific integrated circuit.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method for migrating objects from a source service to a target service, the method comprising:
with a migrating system:
generating a migration list, the migration list comprising a number of objects to migrate from a source service to a target service;
loading a number of object migration jobs into a network-accessible work queue, the object migration jobs representing tasks that define how the objects are to migrate;
retrieving, from the network-accessible work queue, the object migration jobs via a number of workers;
loading the objects from the source service into the target service via the number of workers; and
validating file checksums of the objects to ensure data integrity of the objects.

2. The method of claim 1, in which the number of workers execute across multiple processes, servers, services, databases, or combinations thereof.

3. The method of claim 1, in which validating the file checksums of the objects to ensure the data integrity of the objects comprises exporting total object counts, names of the objects, metrics, or combinations thereof.

4. The method of claim 1, further comprising executing a verification script to rectify errors, alert a user if any of the objects are in a stuck state, or combinations thereof.

5. The method of claim 1, in which the network-accessible work queue comprises a structured query language (SQL) queue, an optimized queue, or a queue service.

6. The method of claim 1, further comprising adjusting parameters of the migrating system.

7. The method of claim 6, in which adjusting the parameters of the migrating system comprises adjusting the parameters for non-destructive shutdowns and restarts, retry timing, simultaneous connections, buffer size, or combinations thereof.

8. A system for migrating objects from a source service to a target service, the system comprising:
with a migrating system:
an adjusting engine to adjust parameters of the migrating system;
a generating engine to generate a migration list, the migration list comprising a number of objects to migrate from a source service to a target service;
an object migration job loading engine to load a number of object migration jobs into a network-accessible work queue, the object migration jobs representing tasks that define how the objects are to migrate;
a retrieving engine to retrieve, from the network-accessible work queue, the object migration jobs via a number of workers;
an object loading engine to load the objects from the source service into the target service via the number of workers;
a validating engine to validate file checksums of the objects to ensure data integrity of the objects; and
an executing engine to execute a verification script to rectify errors and alert a user if any of the objects are in a stuck state.

9. The system of claim 8, in which the number of workers execute across multiple processes, servers, services, databases, or combinations thereof.

10. The system of claim 8, in which the validating engine validates the file checksums of the objects to ensure the data integrity of the objects by exporting total object counts, names of the objects, metrics, or combinations thereof.

11. The system of claim 8, in which the adjusting engine adjusts the parameters of the migrating system for non-destructive shutdowns and restarts, retry timing, simultaneous connections, buffer size, or combinations thereof.

12. A computer program product for migrating objects from a source service to a target service, comprising:
a tangible computer readable storage medium, said tangible computer readable storage medium comprising computer readable program code embodied therewith, said computer readable program code comprising program instructions that, when executed, causes a processor to:
with a migrating system:
adjust parameters of the migrating system;
generate a migration list, the migration list comprising a number of objects to migrate from a source service to a target service;
load a number of object migration jobs into a network-accessible work queue, the object migration jobs representing tasks that define how the objects are to migrate;
retrieve, from the network-accessible work queue, the object migration jobs via a number of workers;
load the objects from the source service into the target service via the number of workers; and
validate file checksums of the objects to ensure data integrity of the objects.

13. The product of claim 12, further comprising computer readable program code comprising program instructions that, when executed, cause said processor to execute a verification script to rectify errors and alert a user if any of the objects are in a stuck state.

14. The product of claim 12, further comprising computer readable program code comprising program instructions that, when executed, cause said processor to export total object counts, names of the objects, metrics, or combinations thereof.

15. The product of claim 12, further comprising computer readable program code comprising program instructions that, when executed, cause said processor to execute the workers across multiple processes, servers, services, databases, or combinations thereof.
